(19) United States
(12) Patent Application Publication
(10) Pub. No.: US 2014/0020537 A1
(43) Pub. Date: Jan. 23, 2014

(54) AUTO-CUTTING APPARATUS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: ZHAO-YONG LI, Shenzhen (CN); QIU-SHENG LU, Shenzhen (CN); JUN ZHANG, Shenzhen (CN); DONG-YUE WU, Shenzhen (CN)

(21) Appl. No.: 13/939,278

(22) Filed: Jul. 11, 2013

(30) Foreign Application Priority Data
Jul. 20, 2012 (CN) 2012102522774

(51) Int. Cl. B26D 7/06; B26D 3/00

(52) U.S. Cl. CPC B26D 7/06; B26D 3/00
USPC 83/401; 83/563

(57) ABSTRACT

An auto-cutting apparatus cuts off burrs from a workpiece. The auto-cutting apparatus includes a work platform, a cutting device, and a control box. The work platform has a work station. The workpiece is placed on the work station. The cutting device is mounted to the work platform, the cutting device comprises a blade. The control box controls the blade to move to the workpiece on the work station to cut off the burrs of the workpiece. The control box controls the cutting device to move the blade away from the workpiece when the redundant part has been cut off.

### BACKGROUND

1. Technical Field

The present disclosure relates to cutting apparatuses, and particularly to a cutting apparatus for automatically cutting plastic pieces.

2. Description of Related Art

Most plastic pieces have burrs after being molded. The burrs need to be removed from the plastic pieces before the plastic pieces can be put to use. However, the burrs are cut manually by cutting tools, such as shears, pliers, and so on, which takes a lot of time for operators.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an auto-cutting apparatus with loaders in accordance with an embodiment. The cutting apparatus includes a cutting device and a work platform.

FIG. 2 is an isometric view of the auto-cutting apparatus in FIG. 1 with one of the loaders separated from it.

FIG. 3 is an isometric view of the work platform of the auto-cutting apparatus in FIG. 1.

FIG. 4 is an exploded view of the auto-cutting apparatus in FIG. 1 with the cutting device separated from it.

FIG. 5 is the auto-cutting apparatus of FIG. 4 viewed from another aspect.

FIG. 6 is a view of the cutting device in FIG. 5 from another aspect.

FIG. 7 is an isometric view of the auto-cutting apparatus in FIG. 1 from another aspect.

FIG. 8 is an isometric view of the auto-cutting apparatus in FIG. 7 viewed from another aspect.

### DETAILED DESCRIPTION

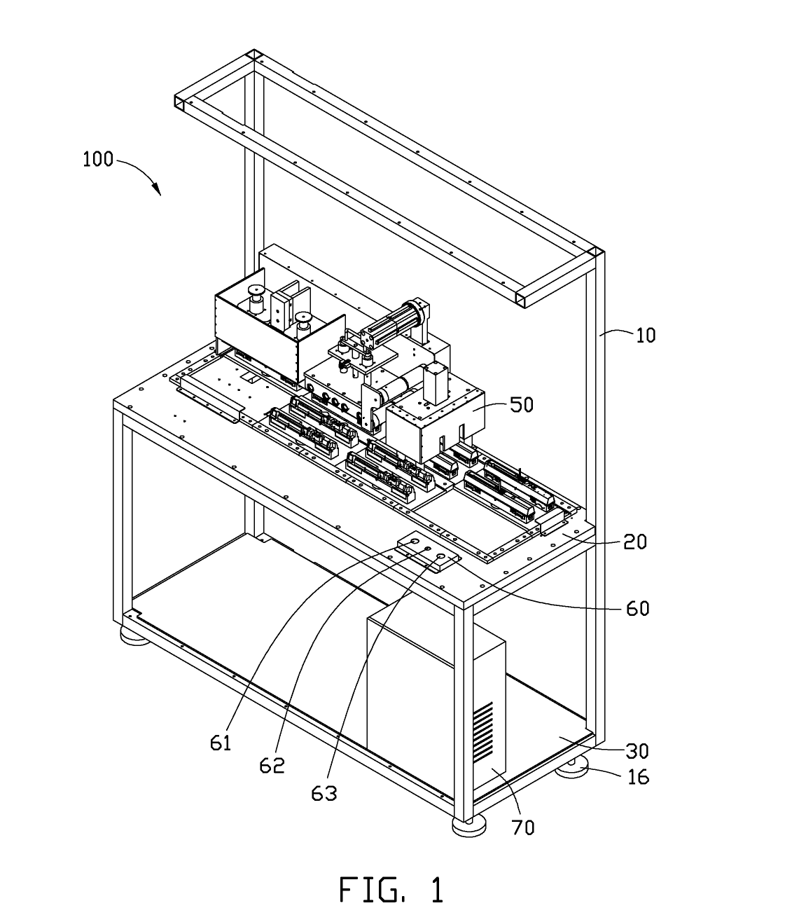

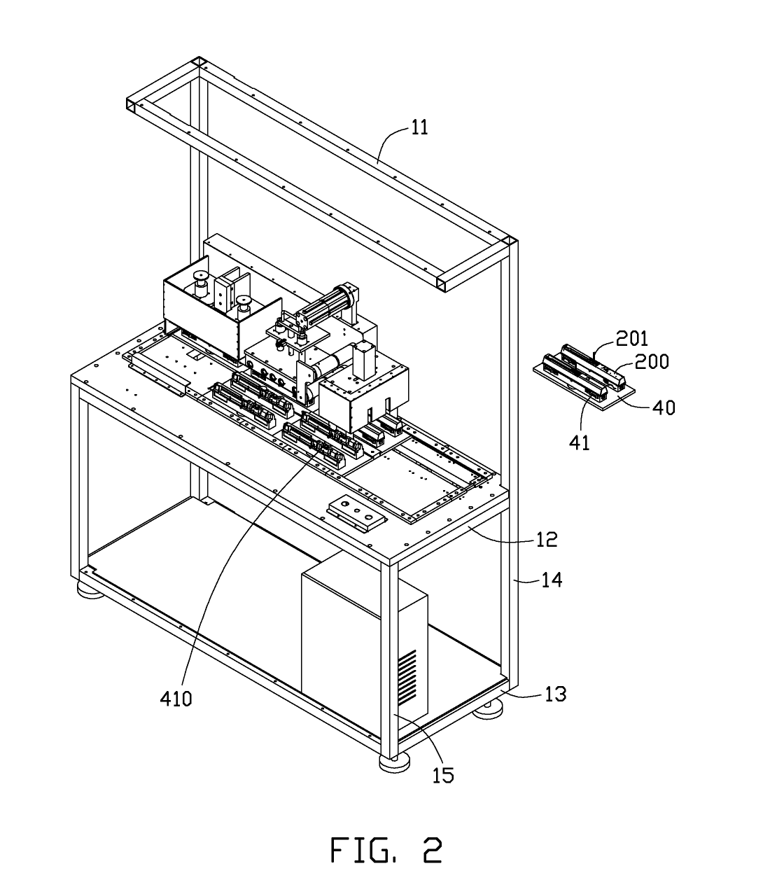

FIGS. 1 and 2 show an embodiment of an auto-cutting apparatus 100. The auto-cutting apparatus 100 removes redundant parts 201 from workpieces 200. In the embodiment, the workpieces 200 are plastic pieces, and the redundant parts 201 are burrs located on a sloped side of the workpieces 200. The auto-cutting apparatus 100 includes a stand 10, a work platform 20, a holding part 30, and a number of loaders 40. The work platform 20 and the holding part 30 are parallel to each other and are secured on the stand 10. The holding part 30 is under the work platform 20. The cutting device 50 is secured on the stand 10 and is above the work platform 20. The loaders 40 are placed on the work platform 20, and slide along the platform 20 for carrying the workpieces 200.

The stand 10 includes a top frame 11, a work frame 12, a holding frame 13, two first shafts 14, two second shafts 15, and four supporting legs 16. The top frame 11, the work frame 12, and the holding frame 13 are parallel to each other, and the work frame 12 is located between the top frame 11 and the holding frame 13. The work frame 12 and the holding frame 13 have substantially the same size, and a width of the top frame 11 is smaller than a width of the work frame 12. The two first shafts 14 are both fixed to the top frame 11, the work frame 12, and the holding frame 13, and are arranged at the same side of the top frame 11, the work frame 12, and the holding frame 13. The two second shafts 15 are both fixed to the work frame 12 and the holding frame 13, and are opposite to the two first shafts 14. The four supporting leg 16 are arranged on a bottom of the holding frame 13 to make the stand 10 rise above the floor. The holding part 30 is substantial rectangular and is placed on the holding frame 13. The work platform 20 is substantially rectangular and is placed on the work frame 12.

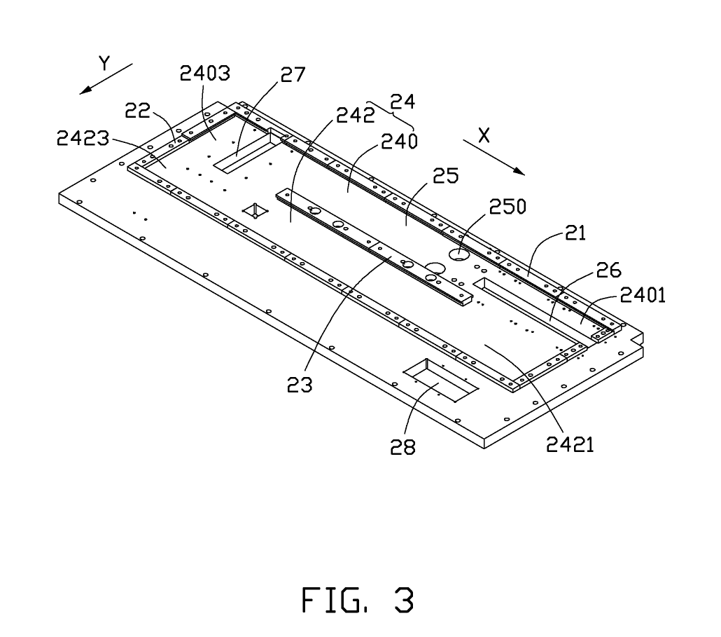

FIG. 3 shows an embodiment of the work platform 20. Two first blocking bars 21, two second blocking bars 22, and a third blocking bar 23 are arranged on a top surface of the work platform 20. The two first blocking bars 21 are parallel to each other. The two second blocking bars 22 are parallel to each other, and are connected between the first blocking bars 21. The second blocking bars 22 and the first blocking bars 21 cooperatively define a rectangular work region 24. The third blocking bar 23 is positioned in the middle of the work region 24, and is parallel to the first blocking bars 21. The third blocking bar 23 is shorter than the first blocking bars 21, such that opposite distal ends of the third blocking bar 23 are separated from the two second blocking bars 22. The third blocking bar 23 divides the work region 24 into an operating region 240 and a waiting region 242 for receiving the loaders 40. The operating region 240 is adjacent to the first shafts 14, while the waiting region 242 is away from the first shafts 14. The operating region 240 and the waiting region 242 are symmetrical with respect to the third blocking bar 23. The operating region 240 includes a first end 2401 and a second end 2403 opposite to the first end 2401. The waiting region 242 includes a third end 2421 and a fourth end 2423 opposite to the third end 2421. The first end 2401 and the third end 2421 meet each other and accommodate one of the loaders 40. The second end 2403 and the fourth end 2404 meet each other and accommodate one of the loaders 40. In this embodiment, each of the waiting region 242 and the operating region 240 can receive four loaders 40.

The work platform 20 further has a work station 25 and defines a first opening 26, a second opening 27, and a third opening 28. The first opening 26, the second opening 27, and the work station 25 are located in the operating region 240. The first opening 26 and the second opening 27 are rectangular and respectively defined in the first end 2401 and the second end 2403. The first opening 26 runs along a first direction X parallel to the first blocking bars 21. The second opening 27 runs along a second direction Y parallel to the second blocking bars 22. The work station 25 is between the first opening 26 and the second opening 27. The work station 25 defines two first through holes 250. The third opening 28 is adjacent to the third end 2421 and is outside the work region 24.

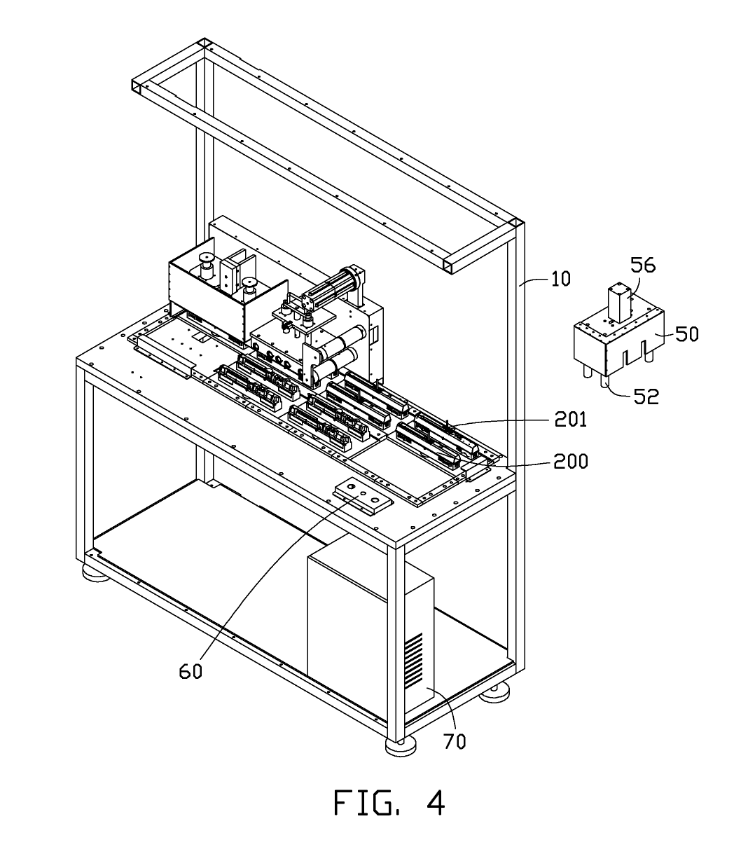

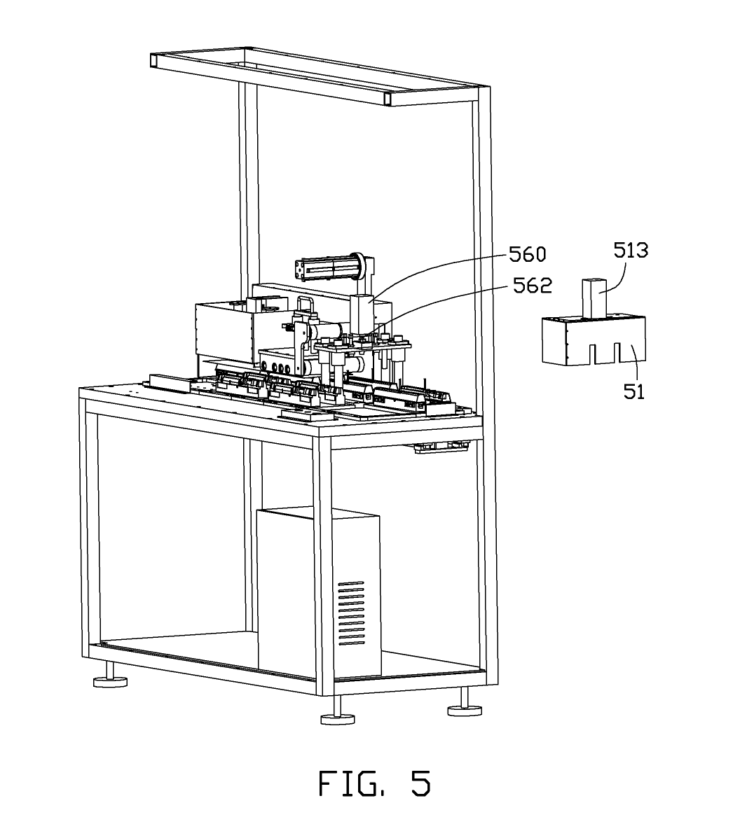

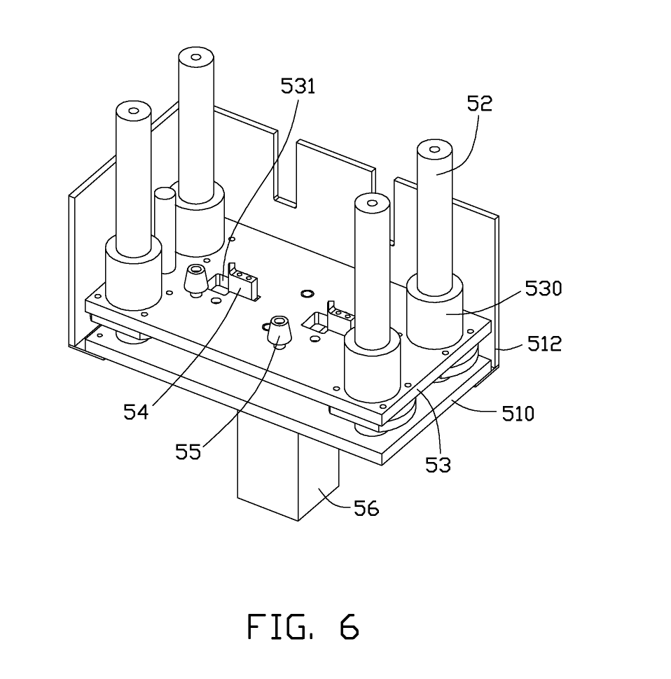

Referring to FIGS. 4 to 6, the cutting device 50 is secured above the work station 25. The cutting device 50 includes a housing 51, four fixing members 52, a movable member 53, two blades 54, two pressing members 55, and a first driving device 56. The movable member 53 is slidably sleeved on the four fixing members 52. The two blades 54 and the two pressing members 55 are fixed on the movable member 53. The two blades 54 correspond to the two first through holes 250. The first driving device 56 is mounted to the housing 51 to drive the movable member 53 to slide along the fixing members 52.

The housing 51 includes a top portion 510, a side wall 512, and a substantially hollow receiving part 513. The top portion 510 is rectangular. The side wall 512 protrudes downwards from the top portion 510 and is arranged on two adjacent sides of the top portion 510. The receiving part 513 protrudes upwards from the top portion 510.

The four fixing members 52 protrude downwards from four corners of the top portion 510, and are secured on the work platform 20 and over the work station 25. Two fixing members 52 are secured on the third blocking bar 23, while the other two fixing member 52 are secured on the first blocking bar 21.

The movable member 53 is rectangular. Four sleeves 530 protrude from the corners of the movable member 53. The four sleeves 530 are sleeved on the four fixing member 52 correspondingly. Two second through holes 531 corresponding to the first through holes 250 are defined in the movable member 53.

The first driving device 56 includes a first driving body 560 and a first driving arm 562 secured to the first driving body 560. The first driving body 560 is received in the first receiving part 513. The driving arm 562 extends through the top portion 510 and is secured to the movable member 53. The first driving body 560 drives the first driving arm 562 to move away from and towards the first driving body 560, causing the movable member 53 to move away from and towards the top portion 510. In its original state, the first driving arm 562 is retracted.

The two blades 54 and the two pressing members 55 are secured on a surface of the movable member 53 away from the top portion 510. Each of the blades 54 is adjacent to a corresponding pressing member 55. The two blades 54 and the two pressing members 55 move with the movable member 53.

Referring to FIG. 2 again, each loader 40 includes two symmetrical positioning portions 41. Each positioning portion 41 positions one workpiece 200. Each positioning portion 41 defines a third through hole 410. The redundant part 201 of the workpiece 200 extends through the third through hole 410. The loaders 40 are caused by an external force to move along the operating region 240 and the waiting region 242. In detail, the loaders 40 move to the operating region 240 from the waiting region 242 via the third end 2421, and move back to the waiting region 240 via the second end 2403.

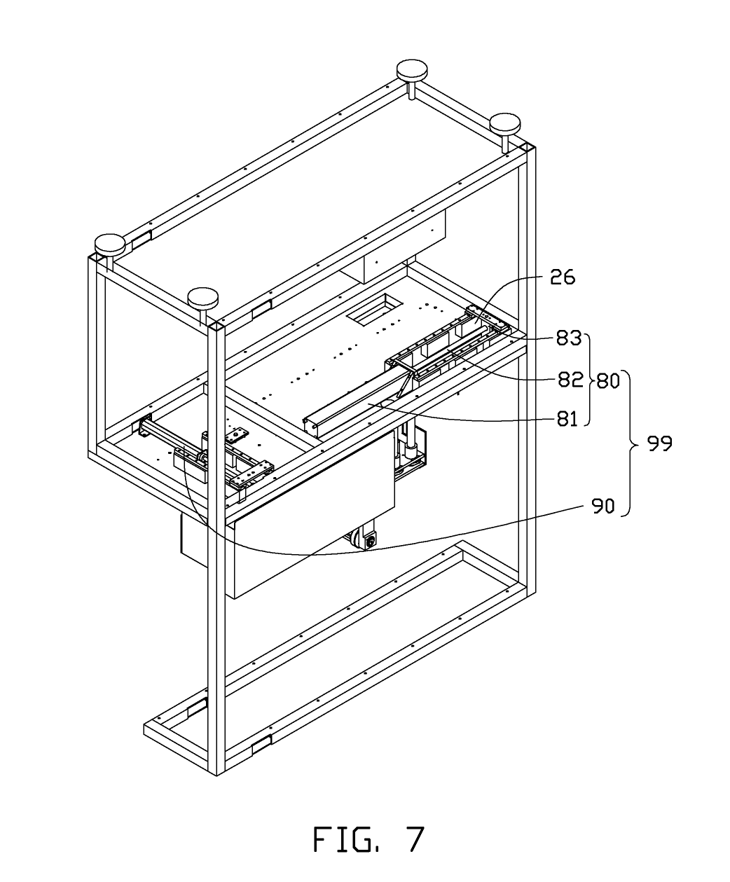

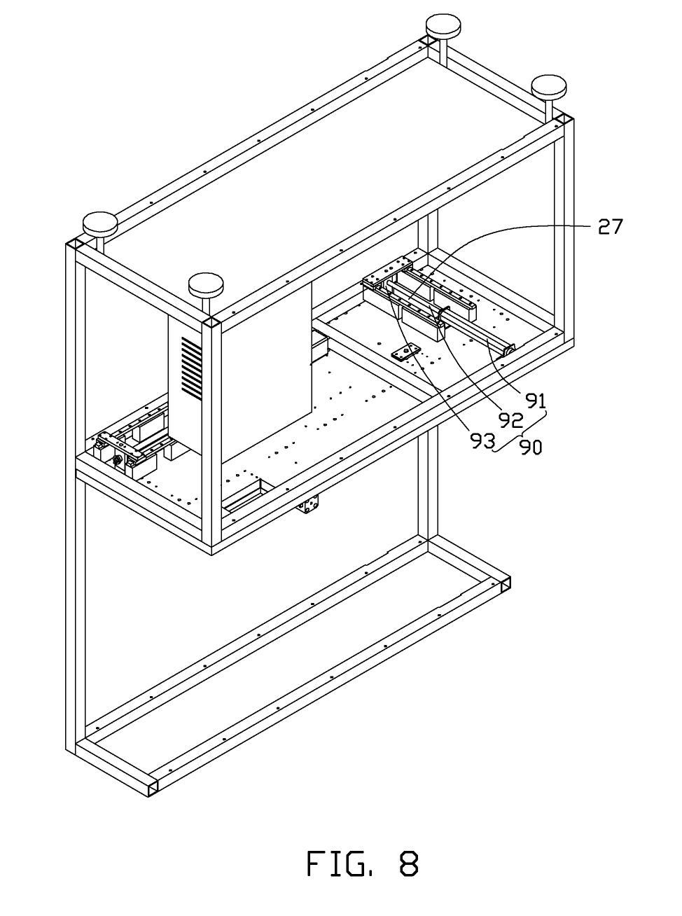

Referring to FIGS. 1, 7 and 8, the auto-cutting apparatus 100 further includes a driving system 99, an operating box 60, and a control box 70. The driving system 99 includes a second driving device 80 and a third driving device 90. The second driving device 80 and the third driving device 90 provide the external force to drive the loaders 40 to move along the operating region 240 and the waiting region 242 along the first direction X and the second direction Y (See FIG. 4).

The second driving device 80 and the third driving device 90 are arranged on the work platform 20, facing the holding member 30. The second driving device 80 includes a second driving body 81, a second driving arm 82, and a first driving block 83. The second driving body 81 is adjacent to the first opening 26. The second driving arm 82 extends along the first opening 26. The first driving block 83 is secured on one end of the second driving arm 82 away from the second driving body 81, and is received in the first opening 26. The second driving body 81 drives the driving arm 82 to move from one end of the first opening 26 to an opposite end of the first opening 26, causing the driving block 83 to move along the first direction X towards and away from the second end 2403. In its original state, the second driving arm 82 is extended to cause the first driving block 83 to abut the loader 40 placed on the first end 2401, such that when the second driving arm 82 retracts, the first driving block 83 pulls the loader 40 towards the second end 2403.

The third driving device 90 includes a third driving body 91, a third driving arm 92, and a second driving block 93. The third driving body 91 is adjacent to the second opening 27. The third driving arm 92 is connected to the third driving body 90 and extends along the second opening 27. The second driving block 93 is secured on the third driving arm 92, and is away from the third driving body 91. The third driving body 91 drives the third driving arm 92 to move from one end of the second opening 27 to an opposite end of the second opening 27, causing the second driving block 93 to move along the second direction Y towards and away from the fourth end 2423. In its original state, the third driving arm 91 is extended to cause the second driving block 93 to abut the loader 40 to be driven to the second end 2403 by the second driving body 81, such that when the third driving arm 91 retracts, the second driving block 93 pulls the loader 40 towards the fourth end 2423. Therefore, the second driving device 80 and the third driving device 90 cooperatively drive the workpieces 200 loaded on the loaders 40 to loop around the work region 24.

The control box 70 is arranged on the holding member 30 for controlling the first driving device 56, the second driving device 80, and the third driving device 90 to enable the cutting apparatus 100 to cut off the redundant parts 201 from the workpieces 200. The operating box 60 is secured in the third opening 28 for controlling the control box 70. The operating box 60 includes a start button 61, a stop button 62, and an indicator 63. When the start button 61 is pressed, the control box 70 starts to work. When the stop button 62 is pressed, the control box 70 stops working. The indicator 63 is configured to inform an operator that the auto-cutting apparatus 100 is not functioning properly, so that the operator can stop the control box 70 by pressing the stop button 62.

In operation, the waiting region 242 is fully filled with loaders 40, and each loader 40 loads two workpieces 200. Next, a first loader 40 is pulled to the first end 2401 manually or by a pulling device (not shown). Next, the start button 61 is pressed manually or by a pressing device (not shown) to start the control box 70. Then, the control box 70 controls the second driving body 81 to drive the second driving arm 82 to move a predetermined first distance, causing the first driving block 83 to push the first loader 40 to the work station 25. At this point, the first through holes 250, the second through holes 531, and the third through holes 410 are aligned. Next, the control box 70 controls the first driving body 560 to drive the first driving arm 562 to move the movable member 53 a second predetermined distance, such that the pressing members 55 press the workpieces 200 of the loader 40, and the blades 54 cut off the redundant parts 201 of the workpieces 200. The pressing members 55 press the workpieces 200 to hold the workpieces 200 securely as the blades 54 cut off the redundant parts 201. The redundant parts 201 are cut off by the blades 54 as the redundant parts 201 pass through the second through holes 531, and the blades 54 pass through the first through holes 250 as they cut off the redundant parts 201. Then, the control box 70 controls the first driving body 560 to return to its original state. Second, third, and fourth loaders 40 are driven by the above procedures, until the first loader 40 is pushed to the second end 4203. Then, the control box 70 controls the third driving body 91 to drive the second driving arm 92 to move the first loader 40 a third predetermined distance into the fourth end 2423 of the waiting region 242, allowing the first loader 40 to be easily removed from the work platform 20. This ends the process for the first loader 40. The process for the workpieces 200 loaded onto the subsequent loaders 40 follows the same procedures as mentioned above.

As described above, the auto-cutting apparatus 100 can cut off the redundant parts 201 of the workpieces 200 automatically, which is more convenient than cutting them off manually. Furthermore, the auto-cutting apparatus 100 cuts off the redundant parts 201 from the workpieces 200 at the same time, doubling the efficiency.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An auto-cutting apparatus for auto-cutting off a redundant part of a workpiece, the auto-cutting apparatus comprising:
a work platform having a work station, the workpiece placed on the work station;
a cutting device mounted to the work platform, the cutting device comprising a blade; and
a control box controlling the blade to move to the workpiece on the work station to cut off the redundant part, and controlling the blade to move away from the workpiece on the work station when the redundant part has been cut off.

2. The auto-cutting apparatus of claim 1, wherein the cutting device further comprises a fixing member, a movable member, and a first driving device, the fixing member protrudes from the work station; the movable member sleeved on the fixing member, the blade is secured on the movable member and faces the work station; the driving device drives the movable member under the control of the control box to move towards and away from the work station along the fixing member.

3. The auto-cutting apparatus of claim 2, wherein the cutting device further comprises a pressing member, the pressing member is secured on the movable member, the pressing member presses on the workpiece placed on the work station for preventing the workpiece from moving with respect to the work station when the blade cuts off the redundant part.

4. The auto-cutting apparatus of claim 1, wherein the work platform further comprises two first blocking bars, two second blocking bars, and a third blocking bar arranged on the work station, the third blocking bar is positioned between the first blocking bars, the first blocking bars are adjacent to two opposite distal ends of the third blocking bars correspondingly and connected between the first blocking bars to define a work region, and the third blocking bar divides the work region into a operating region and a waiting region for receiving the workpiece.

5. The auto-cutting apparatus of claim 4, wherein the operating region and a waiting region are symmetrical with respect to the third blocking bar, and the blade faces the operating region.

6. The auto-cutting apparatus of claim 4, wherein the opposite distal ends of the third blocking bar are separated from the two second blocking bar, and the workpiece is capable of moving from the waiting region to the operating region and back to the waiting region via the spaces between the third blocking bar and the second blocking bars.

7. The auto-cutting apparatus of claim 4, wherein the operating region comprises a first end and second end opposite to the first end, the waiting region comprises a third end and a fourth end opposite to the third end, the first end meets the third end, the second end meets the fourth end.

8. The auto-cutting apparatus of claim 4, further comprising a loader, the loader loads the workpiece and capable of moving in the waiting region and the operating region.

9. The auto-cutting apparatus of claim 8, wherein the loader moves from the third end to the first end, and moves from the second end to the fourth end.

10. The auto-cutting apparatus of claim 4, further comprising a second driving device, the second driving device driving the workpiece to move from the first end to the second end.

11. The auto-cutting apparatus of claim 4, further comprising a third driving device, the third driving device driving the workpiece to move from the second end to the fourth end.

12. An auto-cutting apparatus, the auto-cutting apparatus capable of cutting off a redundant part of a workpiece, the auto-cutting apparatus comprising:
a work platform having a work station;
a control box controlling the workpiece to move to and away from the work station; and
a cutting device mounted to the work platform, the cutting device comprising a blade capable of moving with respect to the work station to cut off the redundant part.

13. The auto-cutting apparatus of claim 12, wherein the cutting device further comprising a first driving device, the first driving device drives the movable member under the control of the control box to move towards and away from the work station.

14. The auto-cutting apparatus of claim 12, wherein the work station includes a work region, the auto-cutting apparatus further comprises a second driving device, the first driving device drives the workpiece to move in the work region.

15. The auto-cutting apparatus of claim 14, wherein work region comprises an operating region and a waiting region separated from the operating region, the operating region comprises a first end and a second end opposite to the first end, the work station is positioned between the first end and the second end, the second driving device drives the workpiece to move from the first end to the second end.

16. The auto-cutting apparatus of claim 15, wherein the second end meets the waiting region, the auto-cutting apparatus further comprises a third driving device, the third driving device drives the workpiece from the second end to the waiting region.

17. The auto-cutting apparatus of claim 16, wherein the first end meets the waiting region.

18. The auto-cutting apparatus of claim 14, further comprising a loader, the loader loads the workpiece and capable of moving in the waiting region and the operating region.

19. An auto-cutting apparatus for cutting a redundant part of a workpiece, the auto-cutting apparatus comprising:
a work platform with a work station;
a cutting device mounted to the work platform, the cutting device comprising a blade, and
a control box,
wherein the control box controls the workpiece to move to the work station, the control box further controls the blade to move to the work station to cut the redundant part when the workpiece is positioned at the work station, the control box further controls the blade to move away from the work station when the redundant part has been cut, and the control box further controls the workpiece to move when the blade has moved away from the work station.

20. The auto-cutting apparatus of claim 19, further comprising an operating region and a driving system, the work station is position at the operating region, the driving system driving the workpiece to move in a first direction and a second directions perpendicular to the first direction to cause the workpiece to move correspondingly.
